(19) United States
(12) Patent Application Publication
(10) Pub. No.: US 2002/0171913 A1
(43) Pub. Date: Nov. 21, 2002

(54) Method and apparatus for acheiving

(75) Inventors: Robert G. Batchko, (US); Larry Marshall, (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Lightbit Corporation

(21) Appl. No.: 09/991,136

(22) Filed: Nov. 16, 2001

Related U.S. Application Data
(60) Provisional application No. 60/249,566, filed on Nov. 16, 2000.

(51) Int. Cl. H01S 3/00

(52) U.S. Cl. 359/333

(57) ABSTRACT

An optical amplifier and a method for using same. The amplifier includes a poled non-linear gain medium such as LiNbO3 and provides waveband optical amplification by difference frequency generation between a data signal and a pump signal. Architectures are provided which realize the amplifier on a single chip. Polarization insensitive architectures are provided, as are methods for tailoring the amplification gain curve.

### CROSS-REFERENCES TO RELATED APPLICATIONS

This application claims benefit of provisional patent applications No. 60/249,566, filed Nov. 16, 2000, and Serial No. ______, filed Aug. 10, 2001, entitled “Low Noise Planar Optical Amplifier.” The materials from the above referenced application are incorporated herein by reference.

### BACKGROUND OF THE INVENTION

1. Field of the Invention

The present invention relates to optical signal amplification, and more particularly to a nonlinear parametric amplifier including a periodically poled non-linear gain medium for three-wave mixing between a signal wave, a pumping wave and an idler wave.

2. Description of the Prior Art

Erbium doped fiber amplifiers (EDFAs) revolutionized the optical communications industry by replacing electrical repeater stations with a pure optical link. The old network architecture using repeater stations is shown in FIG. 1. In repeaters, optical signals are converted from photons into electrons which are then filtered, amplified electrically and then converted back into photons by electrically driving another laser. Before the advent of EDFAs, this OEO conversion process was the only means of amplifying an optical signal. Repeaters were required for each optical channel and each fiber—thus greatly limiting the expansion of technologies such as WDM which employed multiple channels and many fibers. EDFAs perform amplification purely in the optical domain, hence eliminating the costly OEO conversion process, the multitude of repeater stations and the high maintenance overhead of repeaters.

Currently, EDFAs are deployed about every 80 km in the fiber, and a single EDFA amplifies every channel simultaneously. Signals still must undergo OEO conversion for the so-called 3R's of telecommunications: Reshaping, Retiming and Regeneration.

As optical pulses pass through a fiber, a number of dispersive and nonlinear effects occur which change the shape and speed of the pulses. In a WDM or DWDM network, there are many wavelengths traveling through the fiber, each of which undergoes a different dispersion—as a result the individual pulse shapes stretch, and the different wavelengths travel at different speeds so that the temporal overlap of each channel is lost. These effects are shown in FIG. 2. OEO regenerators correct these effects by literally re-creating the signal from scratch so that the original pulse shapes and timing can be restored. Additionally, the re-created signals are output from new lasers at their original optical signal strengths, so that they are amplified or “regenerated.” The cost of OEO regenerators is higher than their predecessor technology, the Sonnet repeater, since the regenerators handle many more channels with DWDM. Therefore there is still a huge cost benefit in eliminating or reducing the frequency of use of OEO regenerators.

The cost of an OEO regenerator increases dramatically with the number of channels being carried, since a new laser is required for each channel—hence WDM and DWDM systems become extremely expensive to regenerate. A typical WDM regenerator costs around 2,000,000. Clearly, an all-optical device like the EDFA is required to eliminate or at least greatly reduce this cost. Typical high gain EDFAs consist of 2 stages, a low-noise preamplifier and a higher-power power amplifier. The pre-amplifier is usually pumped at 980 nm, while the power amplifier is generally pumped at 1280 nm. Unfortunately, EDFAs not only amplify the optical channel but also amplify noise, and add additional noise to the original signal—thus a signal can only be amplified a limited number of times before OEO regeneration is required.

When an EDFA amplifies a telecom signal, it adds inherent noise to the output due to amplified spontaneous emission (ASE). As shown in FIG. 4, a weak input signal at a particular wavelength is amplified, but a minimum of 4.5 dB additional “noise” is added to the signal and to all wavelengths around the signal within the gain band of the EDFA (usually the entire C-band). Furthermore, any noise on the input signal itself is also amplified. Thus each EDFA in a system further degrades the signal to noise ratio S/N until OEO regeneration is required Although the minimum added noise in an EDFA is around 4.5 dB, typical industry standard devices operate around 6 dB added noise. The quantum limited noise performance of a perfect carrier inversion amplifier is 3 dB. If this limit could be reached, then signals could propagate 50% further than is currently possible, before added noise exceeds acceptable limits. With a nonlinear amplifier it is possible to go below the 3 dB noise limit, since the present invention does not have ASE or energy storage in an upper energy level. The present invention offers the potential for true optical regeneration in which the signal is amplified without adding noise.

A further disadvantage associated with EDFAs is their non-uniform gain curve. The gain spectrum of an EDFA is highly non-uniform as shown in FIG. 5. FIG. 5 illustrates that the EDFA gain profile is characterized by high-gain peak, and a long low-gain tail. In order to flatten the gain profile, filters are added which attenuate the gain at the peak of the gain profile until it matches that in the tail—as a result, up to 15 dB of gain is “wasted”.

Raman amplifiers offer an alternate low noise amplification solution, however they are of limited gain (below 20 dB), they have highly non uniform gain (gain profile is usually triangular starting at zero at the pump wavelength and increasing linearly with wavelength until dropping abruptly to zero at the cutoff wavelength), and very inefficient gain requiring 5 times higher pump power than EDFAs to achieve comparable gain. Raman amplifiers are typically used as low noise pre-amplifiers for EDFAs. However, Raman is a distributed amplifier technology, while EDFAs are discrete. Clearly better optimized products that do not require a paradigm shift, could be made with an integrated low noise amplifier and EDFA.

The numerous noise and gain uniformity disadvantages of the prior art amplification systems are overcome by the invention described herein.

### BRIEF SUMMARY OF THE INVENTION

Accordingly, an optical amplifier and a method for using same are provided herein including a periodically poled non-linear gain medium, means for injecting pumping light and a data signal so that the two signals co-propagate in the medium, and means for extracting the amplified signal and the resultant idler wave. According to one aspect of the invention, the non-linear gain medium is a periodically polled LiNbO₃ waveguide. According to other aspects of the invention, the non linear material is MgO:LiNbO3, Lithium Tantalate or a periodically grown semiconductor material. Still further aspects of the invention enable the waveguide to be fabricated according to any of the known methods for providing waveguides in bulk material including, but not limited to, According to another aspect of the invention, the pumping source is a laser diode in the 700-950 nm range. Other embodiments of the invention use pumping light at substantially 940 nm, whereas other embodiments use longer wavelength pumping sources and a frequency doubler in order to move the pumping wavelength into a band of interest.

According to another aspect of the present invention, serrations, teeth or other coupling elements are provided on the LiNbO₃ waveguide for diffractive coupling. According to another aspect of the invention, the end of the waveguide is angle cut to avoid retro-reflections. According to yet another aspect of the present invention, structures are provided that are internal to the waveguide to allow signal and pumping light to propagate through the waveguide multiple times. Embodiments of the present invention allow for multiple PPLN amplification stages to be “daisy chained” to achieve higher gain levels. As used herein, “daisy-chaining” refers to the series connection of multiple amplification stages so that the output of a first stage is connected to the input of the next stage in the series. Other embodiments provide for PPLN amplification stages to be connected in series with other types of optical amplifiers, such as EDFAs, to achieve high amplification with flat spectral response.

According to another aspect of the present invention, unpolarized signal light is amplified by separating the signal light into its orthogonal polarization components, rotating one of the polarization components 90° and propagating each of the signals through a PPLN device with a pumping signal such that each separated signal's polarization axis is substantially identically oriented with respect to a polarization axis of the PPNL. Further aspects of the present invention provide for the “daisy-chaining” of these polarization insensitive amplifiers to achieve higher gain levels. In some embodiments of the instant invention, multiple PPLN amplification stages and multiple polarization insensitive PPLN amplifiers are integrated on a single LiNbO₃ substrate.

A further embodiment of the invention allows for the power of the pumping source to be adjusted in response to the idler wave signal. In yet another aspect of the invention, monitoring the idler wave levels can be used to combat multi-channel crosstalk. Aspects of the present invention provide a method for spectrally flat amplification of a data signal by applying the data signal to a PPLN amplification stage and another optical amplifier in series. One method of the present invention allows for the PPLN amplification stage to be configured so that its spectral gain curve balances the gain curve of the other optical amplifier. An additional method of the invention allows for the other optical amplifier to be an EDFA. Yet further aspects of the invention provide multiple pumping sources to tailor the gain curve of the amplifier over a wide wavelength range of interest.

One embodiment of the present invention allows for the integration of a PPLN device and a silica integrating waveguide segments through the use of diffractive coupling elements arranged on the PPLN device. Another embodiment of the invention enables in-process testing of silica integrated waveguides by optically coupling the waveguides with a PPLN device and routing signals through the resultant assembly. A further embodiment of the present invention allows testing of silica integrated waveguides at the wafer level prior to dicing.

The invention as described herein overcomes the disadvantages of prior art amplification methods by providing a low noise, high-bandwidth means amplifier which is capable of use with commercially available pumping sources. Additionally, the present invention is well suited for on-chip integration and for use as a silica integrated waveguide testing and characterization method.

A further understanding of the nature and advantages of the present invention herein may be gained by reference to the remaining portions of this specification and the attached drawings. Further features and advantages of the present invention, as well as the structure and operation of various embodiments of the present invention, are described in detail below with respect to the accompanying drawings.

### BRIEF DESCRIPTION OF THE DRAWINGS

FIG. 1 shows the prior art use of OEO regenerators in optical networks;

FIG. 2 shows the dispersion effects that degrade optical signal quality over long transmission distances;

FIG. 3 shows a schematic of an amplifier according to one aspect of the invention and the frequency spectrum associated with difference frequency generation;

FIG. 4 shows the effect of EDFA amplification on a signal and the resultant introduction of noise;

FIG. 5 shows the prior art method for flattening an EDFA gain curve by incorporating filters;

FIG. 6 shows a schematic of an amplifier according to the present invention;

FIG. 7a shows two amplifier chips according to the present invention butted together to increase path length in the gain medium;

FIG. 7b shows a gain medium architecture according to the present invention incorporating a small radius bend in an embedded waveguide;

FIG. 8 shows a gain medium architecture according to the present invention incorporating a small radius bend in an embedded waveguide and a frequency doubling stage on a common chip;

FIG. 9 shows a method for controlling pump power in an amplifier according to the present invention;

FIG. 10 shows a method according to the current invention which enables monitoring of the converted wave to control pump power;

FIG. 11 shows a polarization insensitive amplifier according to the present invention;

FIG. 12 shows a further polarization insensitive amplifier according to the present invention incorporating an integrated quarter-wave plate and reflector within the gain medium;

FIG. 13 shows a further integrated polarization insensitive amplifier according to the present invention;

FIG. 14 shows a further integrated polarization insensitive amplifier according to the present invention;

FIG. 15 shows a further integrated polarization insensitive amplifier according to the present invention;

FIG. 16 shows the wide-band gain curve of an amplifier according to the present invention using multiple pump frequencies;

FIG. 17a shows a substantially flat C-band gain curve associated with an amplifier of the present invention;

FIG. 17b shows that manipulation of the gain curve can be accomplished by varying the pump wavelength and grating spacing of an amplifier according to the present invention;

FIG. 17c shows that further manipulation of the gain curve can be accomplished by varying the pump wavelength and grating spacing of an amplifier according to the present invention;

FIG. 18 shows a method according to the present invention of stabilizing pump power output by monitoring the pump power output and controlling the pump's temperature;

FIG. 19a shows that according to an aspect of the present invention, arbitrary gain profiles can be realized by the pumping power of multiple pumping sources;

FIG. 19b shows that an amplifier according to the present invention may be configured to produce a gain curve which is the inverse of the gain curve of an EDFA;

FIG. 20 shows how an EDFA and a PPLN amplification stage may be combined to produce a further amplifier according to the present invention, and further how such a combination may result in a combined gain curve which is substantially flat over a wide wavelength range.

FIG. 21a shows an amplifier according to the present invention in which the powers of two pumping sources are dynamically controlled;

FIG. 21b shows how dynamically varying the powers of two pumping sources according to the present invention can result in an adjustable gain curve;

FIG. 22a shows that bandwidth of an amplifier according to the present invention depends somewhat upon the separation of the wavelength to be amplified and the pump wavelength;

FIG. 22b shows pump regions usable by an amplifier according to the present invention to achieve gain over a wide wavelength range;

FIG. 23 shows a schematic of an amplifier according to the present invention capable of operating in both the L and C bands;

FIG. 24 shows how a fundamental and doubled pump may be combined in an amplifier of the present invention to expand the arnplifier's bandwidth;

FIG. 25 shows a schematic according to the present invention incorporating multiple pump sources to expand bandwidth;

FIG. 26 shows cut surface waveguides according to the present invention;

FIG. 27a shows how the present invention may be implemented in buried waveguides;

FIG. 27b shows a further implementation of the present invention incorporating a buried waveguide;

FIG. 28 shows the relationship between gain and PPLN amplification stage length for various waveguide configurations according to the present invention;

FIG. 29 show how an amplifier according to the present invention may simultaneously amplify multiple signals on discrete paths;

FIG. 30 shows a backward pumping architecture where the data signal and pump signal counter propagate through the gain medium;

FIG. 31 shows how an amplifier according to the present invention may be used to amplify signals in the 1310 nm regime;

FIG. 32 shows an amplifier according to the present invention wherein multiple waveguides are fabricated in a single chip and the amplifier is optimized for one or more pumps;

FIG. 33 shows a gain efficiency contour plot of a periodic poled LiNbO₃ amplifier according to the present invention;

FIG. 34 shows a gain efficiency countour plot of an alternative periodic polled LbNbO₃ amplifier configured to be usable with a wide range of pumping wavelengths;

FIG. 35 shows a polarization insensitive PPLN amplifier according to the present invention;

FIG. 36 shows a “daisy-chained” series of polarization insensitive amplifiers according to the present invention;

FIG. 37 shows an assembly comprising a PPLN device coupled to a silica integrated waveguide via coupling elements arranged on the surface of the PPLN;

FIG. 38 shows a method for in process testing of silica integrated waveguides at the wafer level using a PPLN device of the present invention;

FIG. 39 shows a plot of the quasi-phasematching grating period for 940 nm pumped difference frequency generation with signal wavelengths near 1.6 μm.

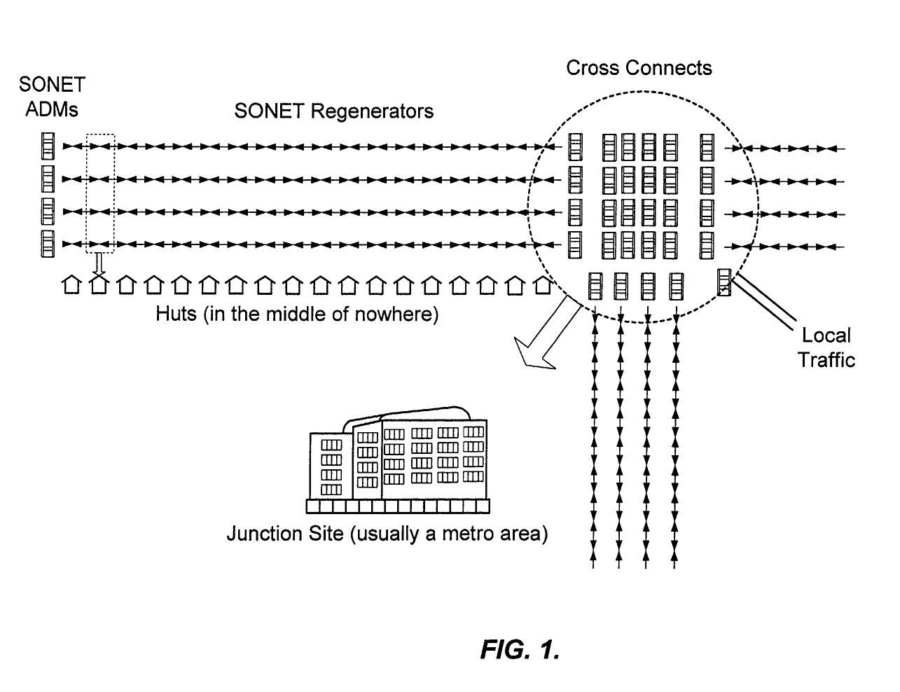

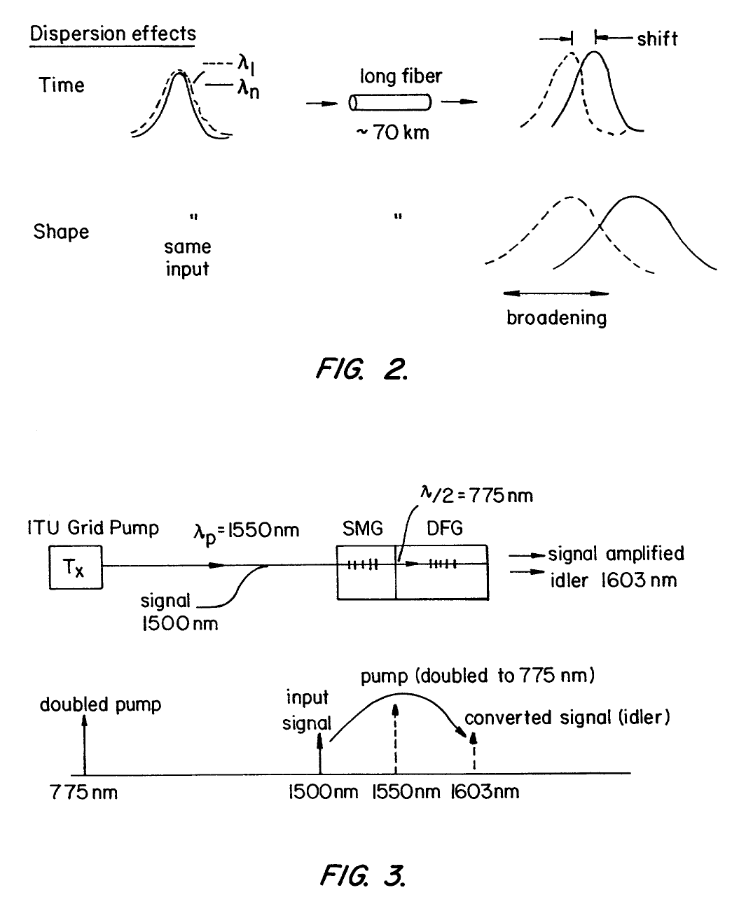

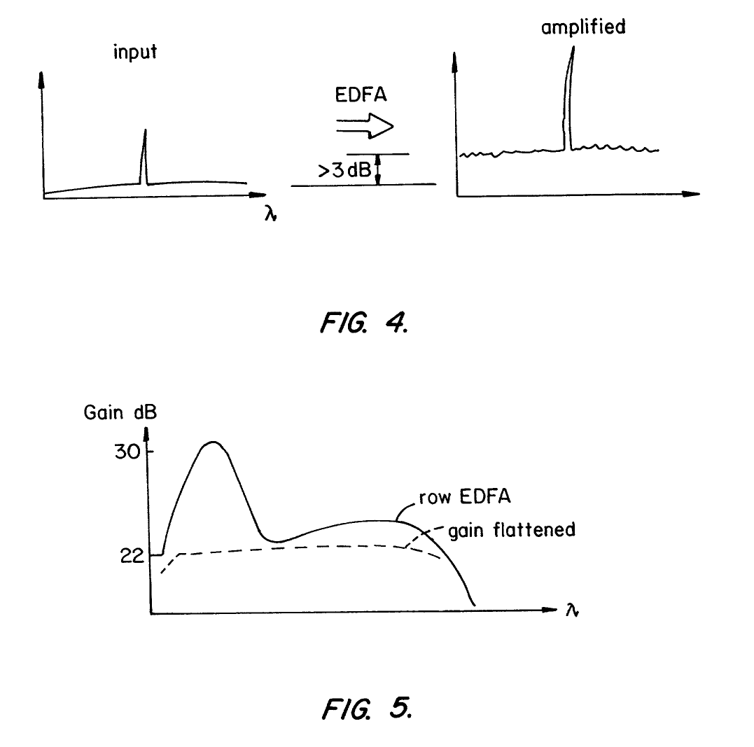

### DETAILED DESCRIPTION OF THE INVENTION

The present invention is based upon all-optical wavelength conversion technology as described in Chou, et al., Optics Letters vol.24, pp. 1157-1159, August 1999, incorporated herein by reference for all purposes, which uses optical parametric amplification (OPA) or difference frequency generation (DFG). An optical parametric oscillator (OPO) is a more general case of a DFG. From a given pump wavelength, an OPO produces 2 outputs of different wavelengths whose energies sum to equal the energy of the pump. For example, a 730 nm pump generates a signal at 1310 nm and an idler at 1648 nm. One can think of an OPO as follows—in frequency space, the pump at frequency ωp forms a “mirror” at ωp/2 and the signal and idler are sidebands or “reflected images” equally spaced on either side of the central pump at frequency ωp/2, as depicted schematically in FIG. 3. In wavelength space, the signal and idler wavelengths “mirror” around 2λp. An optical parametric amplifier (OPA) is an OPO without a cavity in which a pump and either a signal or idler is injected which is subsequently amplified and generates a side band as shown in FIG. 3.

For efficient interaction between the waves, either their speeds must match, or there must be some mechanism for compensating for the walk-off between wavefronts. This compensation mechanism is called quasi-phasematching. Quasi-phasematching can by achieved by mixing the three-waves in a periodically poled substance such as a crystal whose structure has undergone spatially patterned periodic re-orientation. In ferroelectric crystals such as Lithium Niobate, the application of high voltage to periodic electrodes can result in the necessary re-orientation of the crystal structure under the electrodes. This process is called periodic poling and the resulting material is called periodically poled lithium niobate (PPLN). The choice of period determines the particular combination of pump, signal and idler waves for which power is transferred efficiently. By patterning the LiNbO3 crystal such that quasi-phasematching occurs between the signal frequency and the pump.

Typical choices for the pump include a direct pump in the 780 nm wavelength regime—herein called the “doubled pump”, or an in-direct pump in the 1540 nm regime, which is doubled into the 780 nm regime on the same chip that performs wavelength conversion. Alternatively, other pumping regimes can be used depending upon the structure of the PPLN.

Although, PPLN is not the only material capable of being used in this manner, for telecommunications applications, in which CW or weak modulated signals are used without significant peak power, the ideal medium for the OPO or OPA is a periodically poled substance such as PPLN, described by Chou, et al., Optics Letters vol.23, pp 1157-1159, Aug 1999, incorporated herein by reference for all purposes. Alternate materials include periodically poled Lithium Tantalate, MgO:LiNbO3, or a periodically grown semiconductor material such as GaAs or InGaAs. The periodic poling achieves non-critical phase matching of a wide range of wavelengths, thereby maximizing the nonlinear gain for even weak CW signals.

The present invention is not a wavelength converter, as described previously by Chou, but rather an optical amplifier with quantum limited noise performance. The Inventors have recognized that in addition to generating output at a new wavelength, as in a wavelength converter, a difference frequency generator also provides amplification of an input signal. By minimizing the waveguide loss for the original signals, without regard to the converted wavelengths, inventor has optimized the amplification of the input signals. The wavelength converter device known in the art is limited in its choice of pump wavelengths by the need to achieve a specific wavelength shift (equal to the wavelength spacing of the input signal and the pump). The present invention optimizes the pump wavelength only to maximize bandwidth and gain of the device.

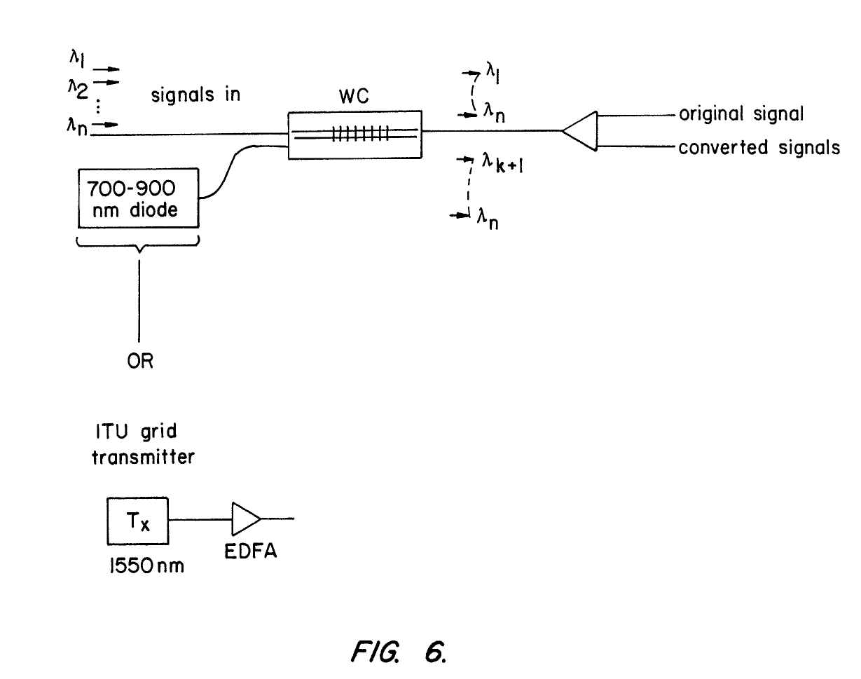

A basic embodiment of the present invention is shown in FIG. 6, where a near-IR laser diode operating at 700-1000 nm is used to pump a PPLN (or other periodically poled substrate) waveguide. A number of input channels propagates through the waveguide and are amplified. In addition, new wavelengths are created on the “opposite” side of the pump to the input channels. These new wavelengths are separated using a simple band pass filter. The rejected new wavelengths can be used as a performance monitor for the amplifier enabling correction functions such as gain balancing and variable optical attenuation.

The gain increases with interaction length and pump power, and with decreasing loss. Instead of using a near-IR diode to pump the waveguide, an ITU grade transmitter operating at 1550 nm can also be used, and amplified with an EDFA gain block to reach several 100 mW output power, as shown in FIG. 6. This source can be frequency doubled using the same grating (periodic poling) which is used for difference frequency generation (DFG).

Maximum gain efficiency is achieved by selecting the pump wavelength (or doubled pump wavelength if doubling is not done on a chip) longer than the wavelength to be amplified, which ensures that the converted wavelengths will be longer than the input wavelengths and therefore draw less energy from the pump than the amplified wavelengths.

Such a device differs significantly from the prior-art wavelength converter embodiments which required very specific pump wavelengths in order to control the wavelength shift of the conversion. The pump wavelength for the present invention can be anywhere in the range 700-1000 nm if used directly, or 1400-1800 nm if frequency-doubled within the waveguide device. Since the gain is flat, centered around the pump wavelength and extends up to 50 nm either side of the pump (in the 1400-1800 band), the primary limitation on pump wavelength is that the gain be in the optimal spectral region for the application requirement.

For amplification of light in the C band, two pumping wavelength ranges are useful: ˜780 nm, and ˜940 nm. In one embodiment of the present invention, the PPLN is patterned to maximize gain in the C-band, between 1530 nm and 1600 nm, when pumped with a 940 nm source. FIG. 33 shows the gain efficiency contour plot associated with a 5 cm long PPLN device fabricated according to this particular embodiment. The plot of FIG. 33 clearly shows wide band region of high efficiency centered about 1550 nm but extending throughout the C-band.

The phenomenon of broad-tuning gain at ˜940 nm is a result of the dispersion properties of lithium niobate. Likewise, the QPM grating period is also a function of the dispersion of the material. As can be seen in FIG. 7, a plot of the QPM grating period (for 940-nm-pumped difference-frequency-generation (DFG)) vs. signal wavelength, at signal wavelengths around 1550 the QPM period is generally insensitive to changes in signal wavelength. It will be understood by those skilled in the art of PPLN waveguides, that Fig. is similar to plots for noncritically phasematched waveguides wherein the phasematching pump wavelength is generally insensitive to changes in the width of the waveguide. In this fashion, pump wavelengths of ˜940 nm and signal wavelengths 1550 nm can be associated with noncritical QPM DFG phasematching. Since the device's power conversion efficiency (i.e., gain) and QPM grating period are both functions of phase mismatch due to material dispersion, the condition of broad-tuning gain can be identified with the condition of broad signal tuning over a given QPM grating period. Further, the dispersion characteristics of a nonlinear material may vary depending on whether the material is un-doped, doped or incorporated within a waveguide. In this fashion, the noncritical QPM DFG condition can be utilized for the specific dispersion properties of a nonlinear material.

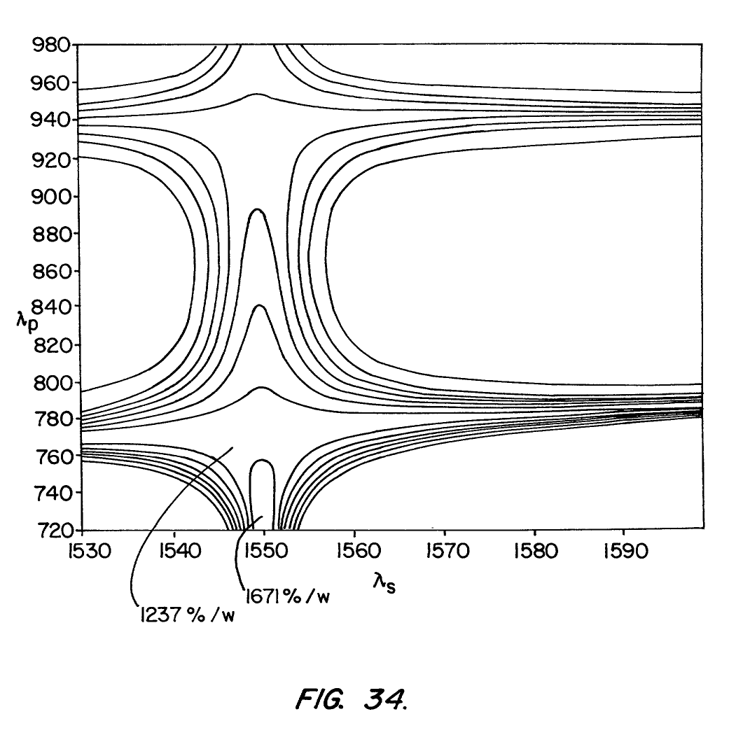

As shown in FIG. 34, an expanded pump-signal-efficiency contour plot of one embodiment of an amplifier according to the invention, the tuning profile at ˜940 nm is flatter and broader at 942 nm than at 780 nm, partly due to the difference in contour tilts. The 780-nm contour ridge slopes away from the signal wavelength (λₛ) axis faster than the 940-nm ridge. Using phase-reversal periodic designs, the signal acceptance bandwidth can be further increased.

One embodiment of the present invention utilizes 940-nm pumps for the amplifier rather than 780-nm pumps. A very significant benefit of this approach in addition to the broader acceptance bandwidth is that it permits use of diodes built around existing technology; 980-nm EDFA pump diodes. These diodes are currently made in volume with stable wavelength output and high power (300 mW). Waveguide devices with ˜1000%/W performance have been demonstrated, so that 300% signal gain can be expected to achieve overall 4× gain, or 6 dB. An issue appears since the gain of this device is so low compared to existing amplifiers (˜20 dB). However, because of the parametric nature of the device, the 0 dB low-gain noise figure permits cascading multiple devices.

Polarization Insensitive Architecture:

Semiconductor-based periodically poled materials do not exhibit polarization dependence, but LiNbO3 does. The input ITU grid signals are not polarized due to propagation over large distances in non-polarization preserving fiber. Thus, the ITU grid input signal in another embodiment, shown in FIG. 11, splits into 2 polarization components which travel identical paths and are wavelength converted then recombined (after a 90 degree rotation either before or after the conversion). The converted signals then travel back down the input path and are separated out by a circulator. The circulator can be placed on either side of the EDFA. Placing it at the input of the EDFA (i.e., left had side of FIG. 11) enables a further amplification of the converted signal after wavelength conversion.

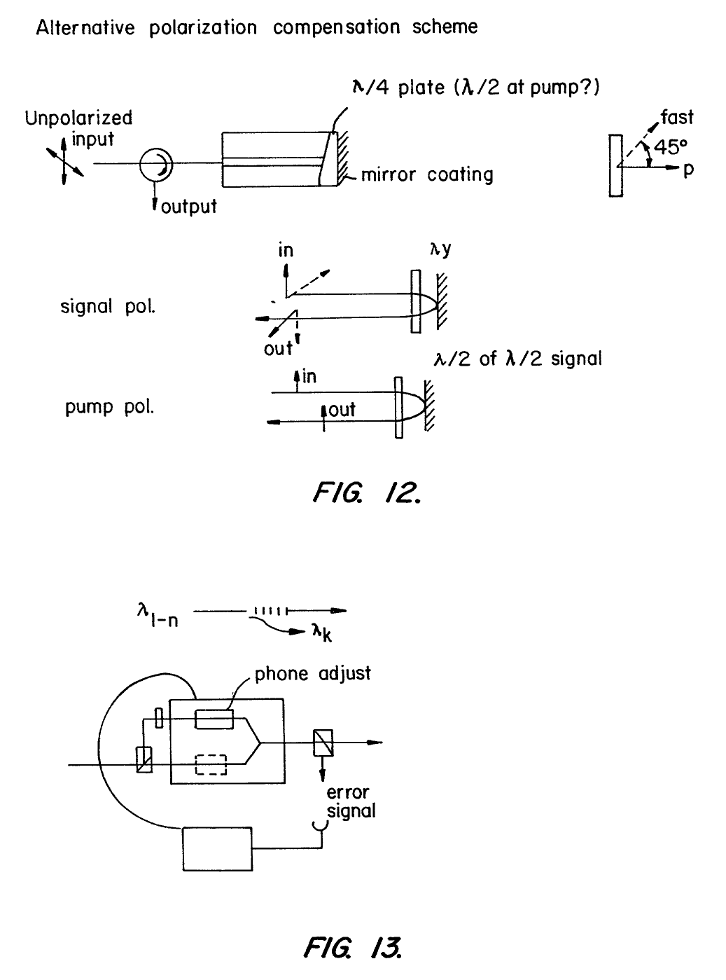

An alternate polarization compensation scheme is shown in FIG. 12. A quarter-wave plate is created, preferably in lithium niobate or the same material as the wavelength converter, with its axis oriented at 45 degrees to the preferred polarization direction of the WC. Since the two materials are identical, they can be butted together without index matching or subsequent losses. Furthermore, the waveguide can be fabricated into the combined substrate (i.e., WC & waveplate) so as to eliminate losses. The exterior surface of the waveplate is coated with a dielectric mirror coating reflecting the pump and signal wavelengths—this coating could also transmit the spectral region into which the converted output will be transmitted, thus eliminating the out of band ASE noise from the EDFA.

The waveplate causes a 90 degree rotation of the input signals, so that the polarization component that was optimal for the forward pass is flipped 90 degrees to the non-converting orientation, and vice versa. The pump is frequency doubled within the waveguide, and the waveplate is fabricated to be quarter wave in the 1550 nm band, and half wave in the doubled band (˜780 nm). Thus the pump polarization remains unchanged on the roundtrip and can still pump the flipped polarization of the signal on the return pass.

Alternatively, an integrated polarization control device can be included in a single waveguide chip structure, as shown in FIG. 13. In this case the polarization components are split, the incorrect polarization rotated by a half wave plate, then recombined in a modified Mach-Zhender structure. One arm of the structured includes a high voltage electrode which applies a refractive index changing electric field thereby controllably varying the optical path difference between the two arms to maintain them in-phase for constructive recombination of the fields. An error signal may be tapped off the orthogonal polarization which is minimized to optimize the correct polarization. Since the telecom signals are very much faster than the variation of polarization in the system, a simple slow detector can average out the variations due to signal rather than actual polarization change. This device can also be integrated onto the same chip as the waveguide array.

The device can also be configured to accept un-polarized light, using the polarization insensitive scheme shown in FIG. 14. Two waveguides are fabricated using Titanium method (as described by UTP) and annealed proton exchange method (APE) which support orthogonal polarization states TE and TM. The splitter then separates unpolarized light into its two orthogonal TE and TM components. A cut is introduced into the waveguide into which a snug fitting half-wave plate is introduced which rotates the polarization of the undesirable component by 90 degrees to match the desirable component. The tow waveguides are the re-combined to produce a single output. If the waveplate material is the same as that of the substrate (e.g. LNbO3), then the optical path lengths will be identical and the recombined beams will add in-phase with minimal loss. A small correction for phase can be introduced by adding a voltage across a portion of one waveguide to vary the refractive index and hence the path length.

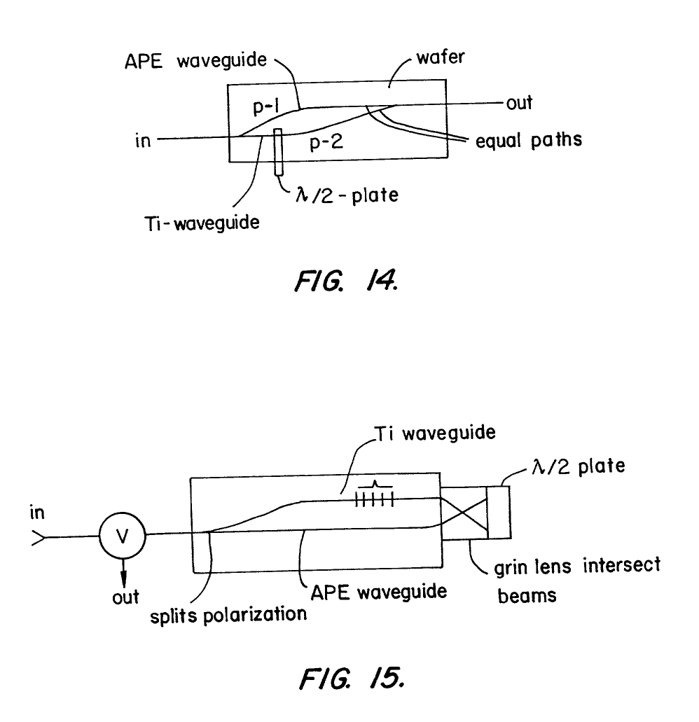

Another method, shown in FIG. 15, uses an integrated approach, again with APE and Ti diffused waveguides which automatically separate the polarization into 1 orthogonal components. In addition, a GRIN lens is configured to reflect and interchange the beams exiting each waveguide at the opposite end of the chip. A quarter-wave plate rotates the reflected light by 90 degrees (2 passes) and the GRIN lens ensures the rotated components enter the appropriate waveguide which supports that polarization. One arm contains the grating and conducts wavelength conversion on only 1 polarization at any time. The reflected beams are recombined at the input of the chip and exit the input fiber via a circulator.

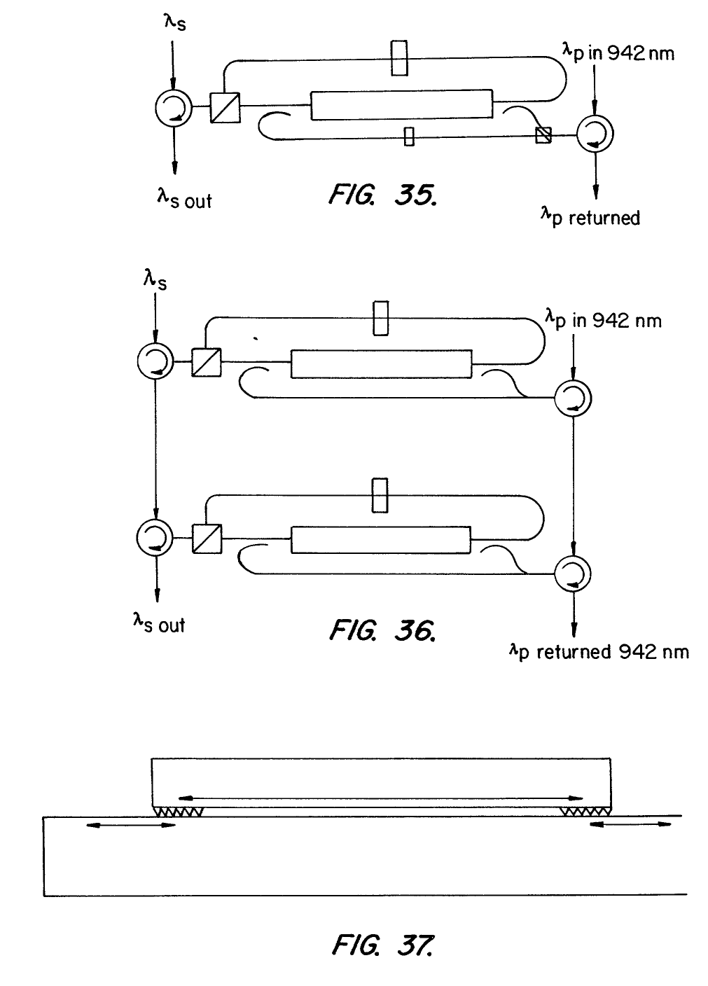

Yet another polarization insensitive architecture is shown in FIG. 35. In this embodiment, the input signal is applied to the PPLN via an optical circulator. Input signal light is then separated into its orthogonal polarization components, for example, s and p polarization states. One of the resultant portions of the signal light, for example, the s portion, is then rotated 90° so that both portions have parallel polarization axes. The pumping light is similarly applied to the PPLN through an optical circulator and undergoes an identical polarization process. The one-half portions of the signal and pumping light are then propagated through the PPLN and recombined. In the embodiment of FIG. 35, portions of the signal and pumping light (resulting from the polarization separation) are counter-propagated through the PPLN before recombination. In another embodiment of the Invention, instead of opposing pump taps, as in FIG. 35, one of the Pump Taps may be replaced with a high-reflector (HR) providing high reflectivity at the wavelength of the pump.

Alternatively, two or more pump diodes may be utilized, at least one for each direction of propagation in the waveguide. The polarization and power level of each pump diode may be independently adjusted to provide polarization diversity. One benefit of using the 942-nm pump is that the photorefractive damage at 780 nm will be reduced, permitting operation of the device at lower temperatures, making the device practical for telecom applications.

Another embodiment of a high-gain polarization insensitive architecture is shown in FIG. 36. In this embodiment, multiple amplifiers may be linked or daisy-chained for additional gain. Further, all the waveguides may be incorporated on the same chip. Yet further, multiple channels of amplification can be integrated onto the same chip. Further still, the gain curve may be engineered using all known techniques to achieve control of the spectral, temporal and spatial properties of the waves propagating through the waveguide. Such engineering techniques include without limitation domain-grating phase reversals, spatial chirping in the domain grating, fanned gratings, segmented gratings, modification of the domain duty cycle, and the use of fourier harmonics in the domain grating periods. Buried waveguides such as reverse-proton exchanged waveguides, may be utilized to improve the mode overlap, and to achieve greater symmetry of the shapes, of the pump, signal and idler waves.

Integrated Coupler

As shown in FIG. 37, amplifiers according to the present invention can be integrated onto silica integrated-waveguide devices to eliminate or reduce the dependence on the use of optical fibers, micro-optics or other couplers. Gratings, serrations or teeth may be employed on the surfaces of either or both of the amplifier chip and the silica integrated-waveguide. In this fashion, light may be coupled between the amplifier chip and the silica integrated-waveguide.

In-situ Testing of Silica Integrated Waveguides

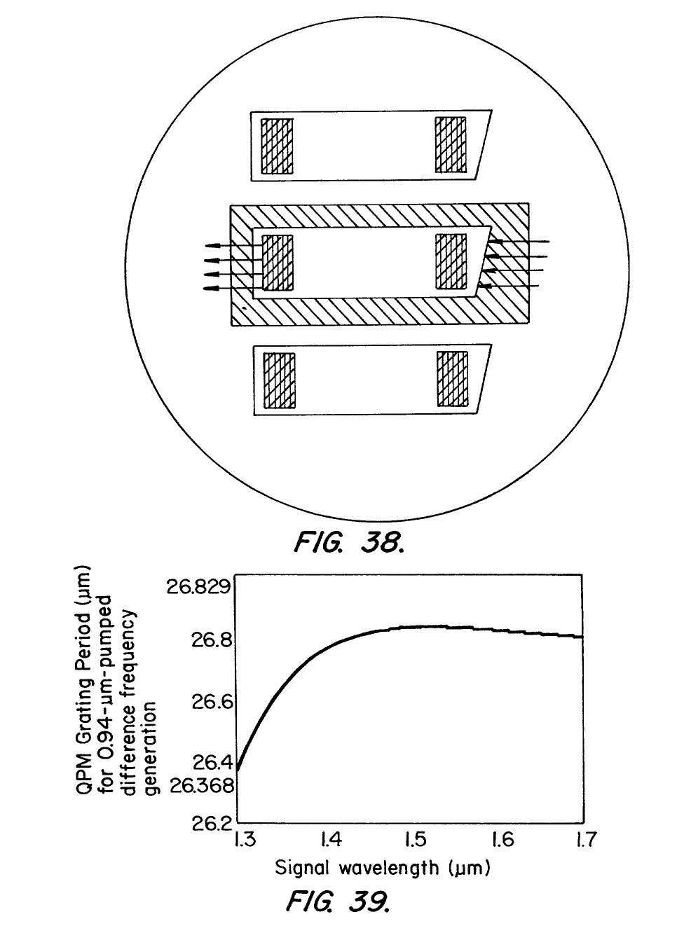

As shown in FIG. 38, silica integrated-waveguide devices can be utilized for characterization and alignment of waveguides at the wafer level. A PPLN amplifier chip with serrations can be placed in contact with a wafer containing multiple integrated waveguides, and a test signal propagated along one of the waveguides and through the amplifier. The test signal can then be detected and analyzed. This allows for in-process testing of the integrated waveguides before they are sawn from the wafer. In a further embodiment of the present invention, the amplifier chips are angle cut in order to avoid internal reflections that may reduce performance.

Bandwidth

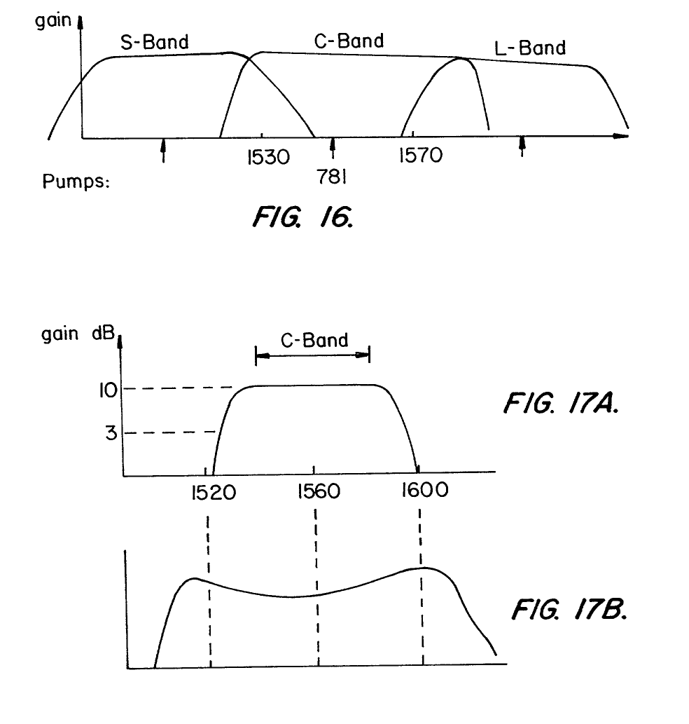

The interaction of the pump and substrate produces gain over a wide range of wavelengths as shown in FIG. 16. As the pump wavelength is tuned, and grating period varied correspondingly, the gain profile is shifted to enable gain across the S, C, or L-Bands, using a 657 nm, 781 nm, 795 nm pump respectively. Thus unlike an EDFA, the present invention offers gain in new regions of the spectrum.

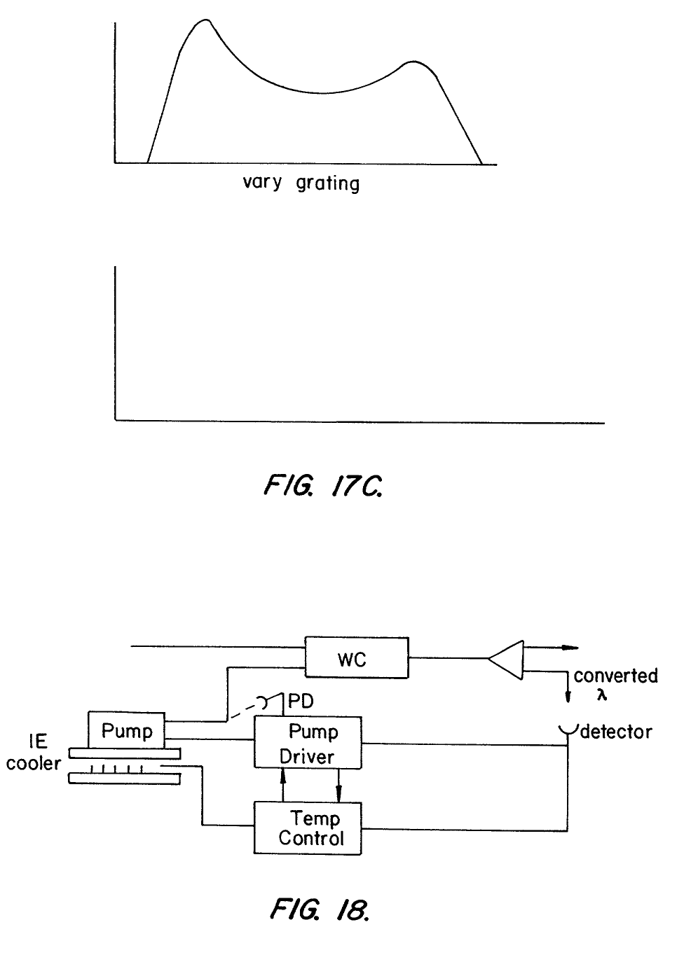

The gain bandwidth of the present invention can also be extended by tuning the pump wavelength, and using a non-uniform grating with a dephasing domain as is known in the art by Chou et al., CLEO'99 CWB8, and included herein by reference. FIG. 17b shows the bandwidth of the amplifier with a 780.2 nm pump and the non uniform grating. The bandwidth in this case reaches 100 nm which encompasses both the C and L bands entirely. No EDFA can achieve this.

The gain of this amplifier is linearly proportional the pump power, so that gain can be varied simply and directly by varying the current to the laser diode. In this event, it is desirable to employ a control loop as shown in FIG. 18, to vary the temperature of the diode in order to maintain constant diode wavelength with current.

Unlike a wavelength converter, the change in diode wavelength does change the gain of the present invention, but does change its bandwidth. In another embodiment, shown in FIG. 17c, the gain bandwidth of the amplifier is optimized for a given channel set by varying the pump wavelength. In a wavelength converter, a change in the pump wavelength renders the converter useless for converting ITU grid channels because the pump wavelength must be locked relative to the ITU grid in order to lock the converted channels on the same grid. The present invention has no such restriction.

Dynamic Gain Control

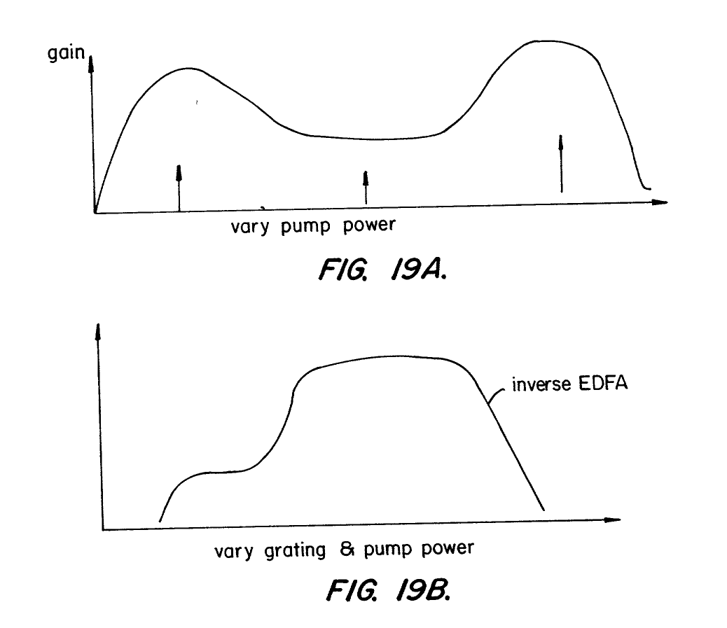

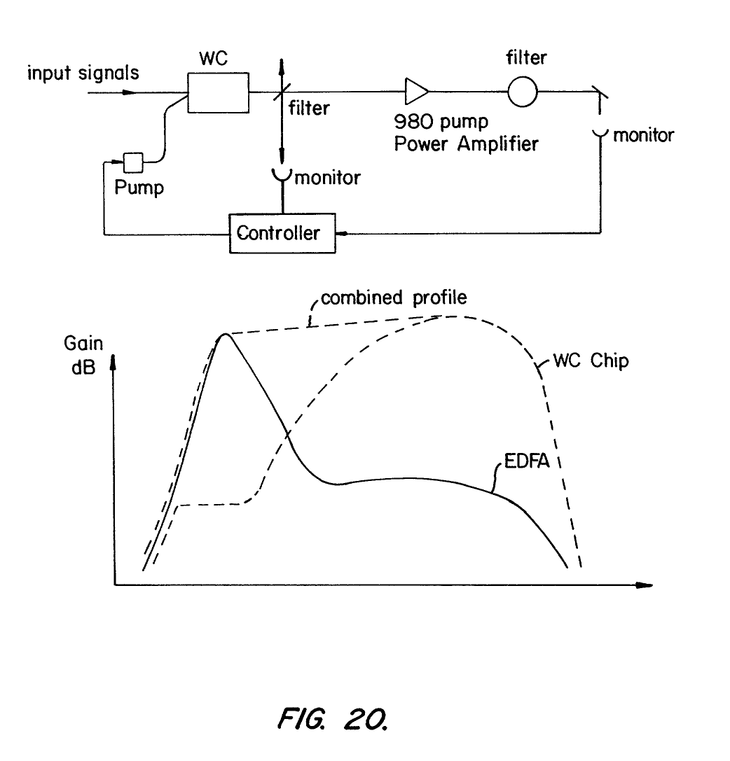

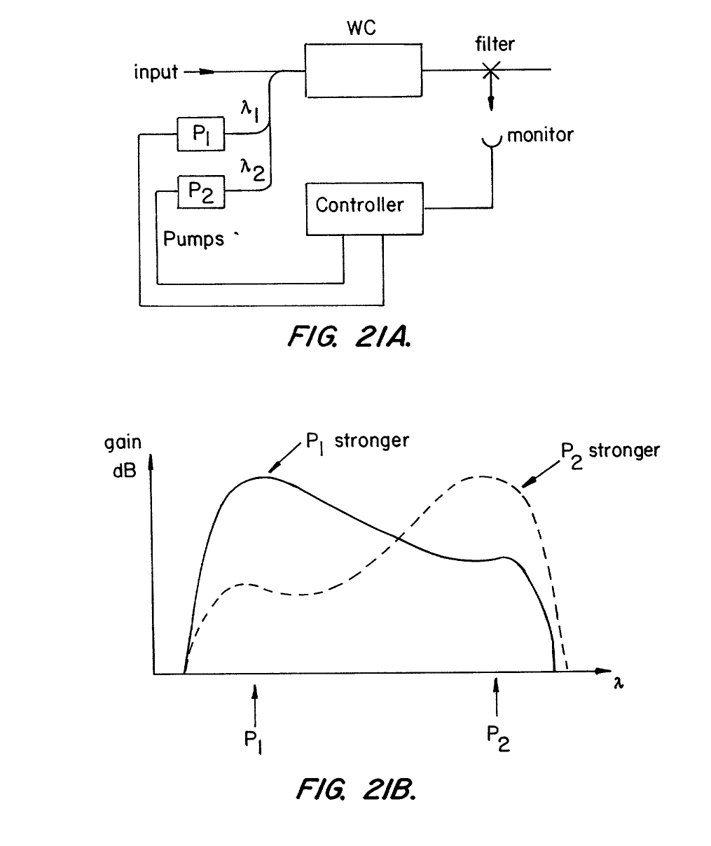

In another embodiment, shown in FIG. 19a, the gain profile of the amplifier is made non-uniform by introducing additional pumps at other wavelengths. With 2 pumps, the gain profile can be peaked at the edges with a dip in the center. This figure is the inverse of the gain profile of an EDFA (FIG. 19b). In a system embodiment, shown in FIG. 20, the present invention is a low noise pre-amplifier which corrects for the gain spectrum of a EDFA power amplifier, as shown in FIG. 21.

As the pump wavelengths or intensities are varied the relative gain levels at the edges and center can be modified to correct for variations in intensity among the input channels. This embodiment, shown in FIG. 21a, enables channel equalization. The ability to rapidly vary the diode wavelength and power (temperature and current) enables dynamic gain equalization in the amplifier, as shown in FIG. 21b.

The converted wavelengths are rejected and then used to accurately measure each of the original channels without introducing losses or attenuation to the original channels, as shown in FIG. 21. Since the energy to create the new wavelengths comes from the pump and not the input channels, the input channels are unaffected. The converted wavelengths are also amplified in the amplifier and therefore can be easily detected without an expensive preamplifier/receiver. This improves signal to noise of the detector and gain control system.

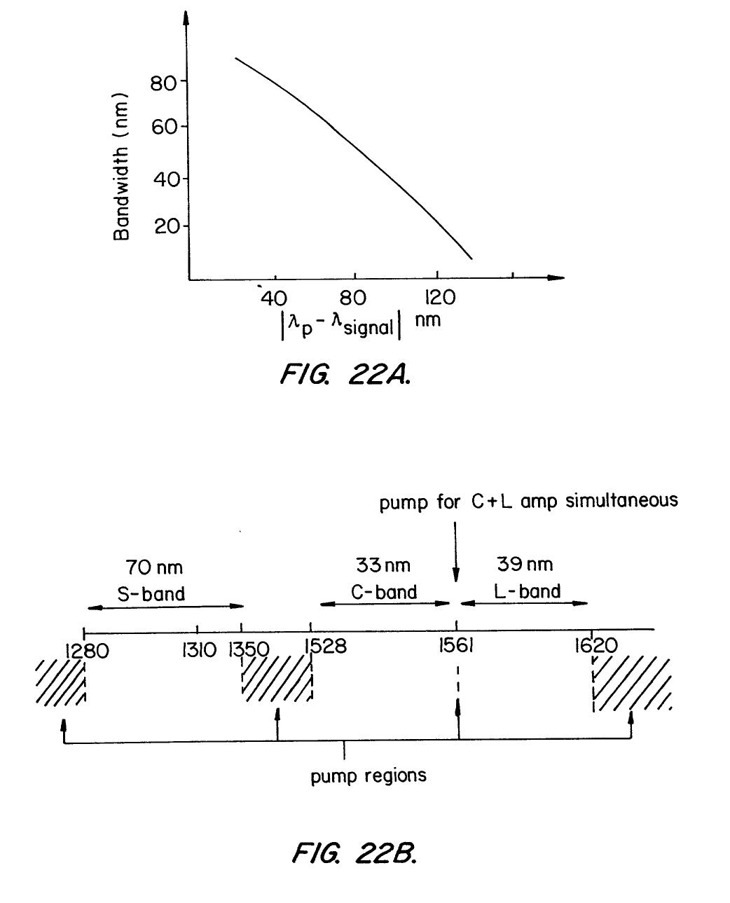

There is another small dependence on pump wavelength, in that the bandwidth of gain depends somewhat upon the separation of the wavelength to be amplified and the pump wavelength. In this case, the bandwidth is centered about the input signal wavelength and the waveguide grating is fabricated to optimize gain in this region. This dependence is shown in FIG. 22. If the signal and pump are close together, the bandwidth is maximized and by default centered around the pump. For example, to amplify signals over a 100 m range from 1530-1600 nm, a pump at 1560 nm (or direct at 780 nm) is required. However, a pump at 1600 nm can be used but if 1500 nm signals are to be amplified, the bandwidth will be reduced to only 50 nm. Further, increased gain bandwidth and stability can be achieved by slightly detuning the pump wavelength away from degeneracy (where degeneracy is defined as the pump wavelength for which the signal and converted wavelengths are equal, and where the pump frequency is twice the signal frequency). Such detuning can be utilized to achieve broader gain bandwidths for the signal, and to allow for drift of the pump wavelength and temperature of the nonlinear gain medium.

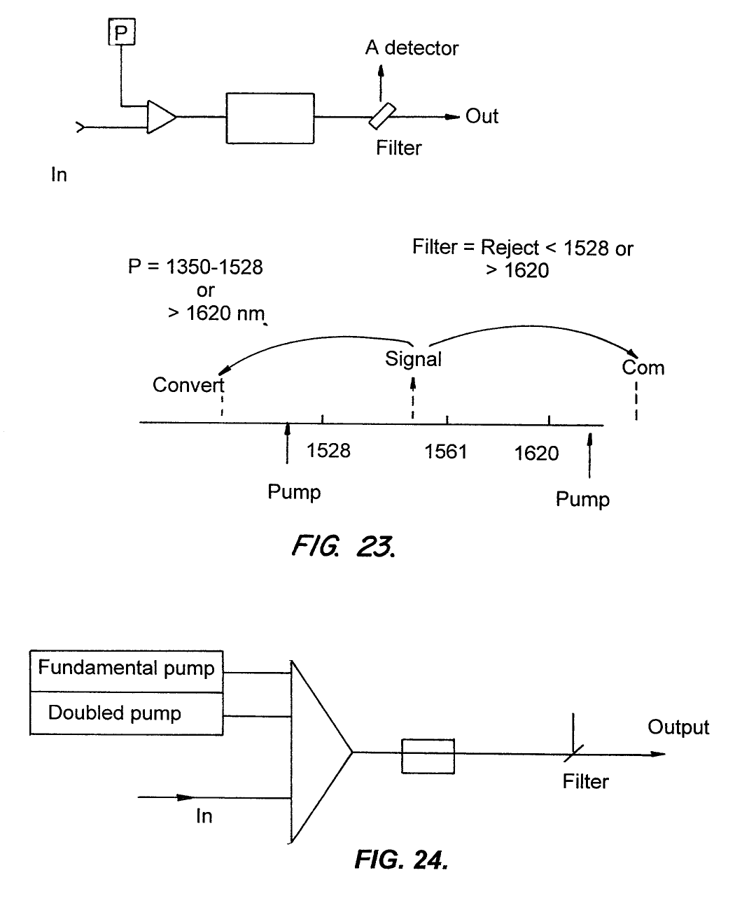

The bandwidth constraint still enables another embodiment of a single pump amplifier, to provide gain throughout the C and L bands simultaneously. Such a device enables a single product to replace two different amplifier products in the current market—i.e., a C-band product and an L-band product. In this case, converted wavelengths occur in the L-band when C-band input is applied and vice versa. This embodiment is shown in FIG. 23, and includes filters to separate the converted wavelengths from the input wavelengths.

Similar embodiments employ pump wavelengths lower than 1280 or higher than 1350 nm for S-band amplification; lower than 1528 or higher than 1561 nm wavelengths for C-band amplification, and lower than 1561 or higher than 1620 nm pumps for L-band amplification, as shown on the spectra chart of FIG. 22a.

Another embodiment, shown in FIG. 24, employs both the fundamental and doubled pump simultaneously. In this case pump power is scaled without producing additional converted waves or reducing gain efficiency. The two pump are easily combined using a dichroic filter assembly, and produce output in the 700-1000 nm and 1400-1800 nm regimes respectively.

The bandwidth can also be increased by fine tuning the pump wavelength with respect to the grating. For example, if the pump is tuned slightly shorter than the resonance wavelength of the grating, the bandwidth is increased, and vice versa. In another embodiment, the device includes a feedback loop which locks the resonance to the pump wavelength to maintain optimum bandwidth by temperature tuning the waveguide grating.

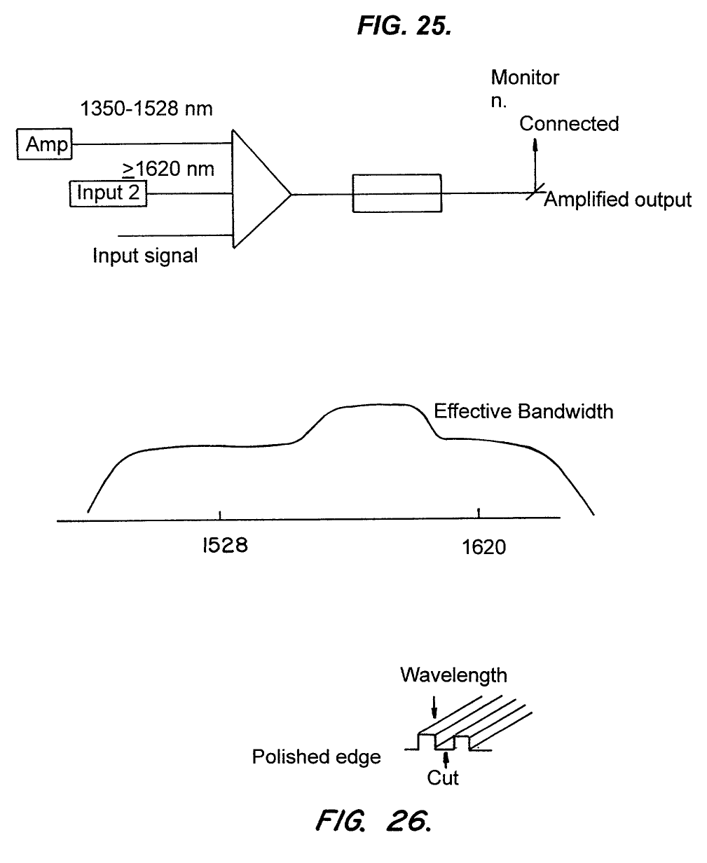

Further increases in bandwidth are achieved using another embodiment in which multiple pumps of different wavelength are employed. In this embodiment, shown in FIG. 25, filters separate the converted wavelengths from the input wavelengths, and the pump wavelengths are chosen to enable maximum usable bandwidth to be achieved. For example, for a C-band amplifier two pumps are employed, one at less than 1528 nm and the other at greater than 1561—i.e., out of C-band pumps. The pump energy is thereby increased by multiplexing two different wavelength pumps together (which is easy using simple di-chroic mirrors and input to the amplifier through a common waveguide), without the need for even higher power pumps. Indeed, additional pumps can be added at other wavelengths outside the C-band (or desired amplification range) to further increase the amplifier gain. Since the pump wavelengths are outside the gain bandwidth, the converted channels do not interfere with the amplified input channels.

When used as a wavelength converter, the linewidth of the pump is critical as the wavelength-converted signal has a linewidth which is a convolution of the pump and input signal, and therefore causes broadening of the converted signal. As a result, only single-frequency sources can be used. The present embodiment enables broader linewidth sources to be used, facilitating use of higher power diodes to achieve higher gains. While some broadening still occurs for the amplified input signal, it is additive to the original signal and therefore occurs predominantly at the base of the spectrum. For example, at 10 Gb/s line rate, the spectral width of the input signal is 0.08 nm (10 GHz), while the linewidth of a stable, single-frequency, CW pump is around 10 MHz. Therefore, the present embodiment can tolerate a pump linewidth up to 1 GHz (0.008 nm) before noticeable signal broadening occurs in amplification, enabling multi-longitudinal mode, higher power pumps to be employed. At higher bit rates such as 40 Gb/s, pump linewidths up to 4 GHz can be used.

The interaction length can be doubled by butt coupling two chips together on a common substrate, as shown in FIG. 7a. Alternately, the length can be increased by introducing a tight radius bend in the waveguide so that the light makes 2 passes through it in the same length of chip, as shown in FIG. 7b.

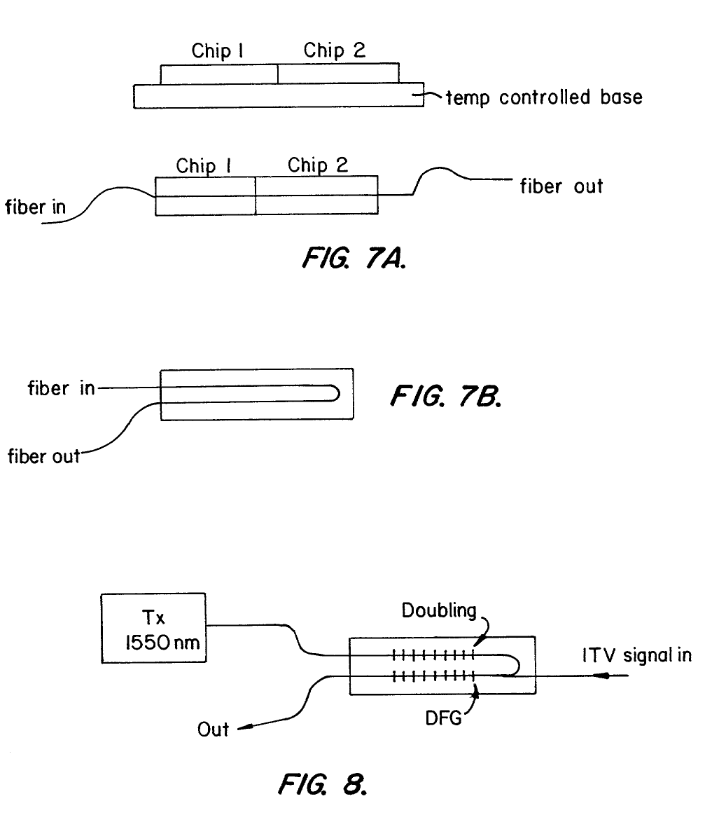

In the embodiment shown in FIG. 8, the tight radius bend enables a first length of waveguide to accomplish frequency doubling of the 1550 nm Telco grade transmitter acting as a pump, and the second pass enables amplification or wavelength conversion.

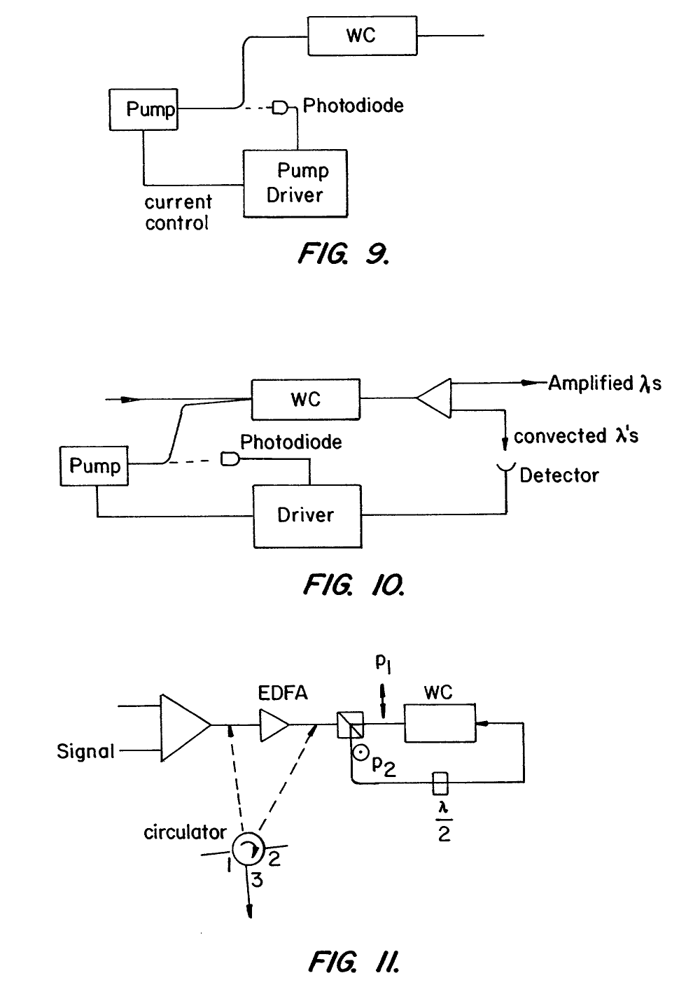

The amplification is a transparent process which adds minimal noise to the original input signal. In order to achieve quantum limited noise performance, the pump must be stabilized. A photodiode detects the output power of the pump and locks this power level by current control, as shown in FIG. 9. Unlike the additive noise from an EDFA, the noise induced by the pump is merely multiplicative noise which does not degrade the signal to noise ratio of the input channels. This noise comes simply from the linear dependence of gain upon pump power.

The response time of the present invention is much faster than the telecommunication signal modulation. In order to avoid crosstalk between input channels the pump power must be large compared to the input channels. For example, if the sum of the energy of the amplified channels is 1 mW (e.g. 10 channels at −10 dBm each), and the pump is 200 mW, then the pump depletion caused by amplification (and wavelength conversion) is 1% which would cause −20 dB crosstalk. In the embodiment shown in FIG. 10, the overall power in the converted channels is monitored, and used to determine pump depletion. The power of the pump can then be adjusted to maintain minimal crosstalk.

Ultra Long Haul Amplifier

In ultra-long haul systems, the present invention can provide substantial gain without crosstalk by its ability to apply low-noise amplification. Signal levels as low as −50 dBm are typically reached in ULH systems, and a pre-amplifier is required to bring them up to minimal detection threshold of −30 to −20 dBm. In this case, over 100 channels can be amplified without extracting more than 1 mW (0 dBm) from the amplifier, thus minimizing crosstalk to <−20 dB, as required. A higher saturation power EDFA can then be used to increase power. In this application, monitoring is critical. Given detection threshold is −30 to −20 dB, the present invention is enabling for low noise, efficient detection and monitoring. Since converted wavelengths reach detection threshold, the present invention provides an independent source of monitoring signals without reducing the intensity of the amplified channels.

Mechanical Waveguides

In another embodiment, shown in FIG. 26, waveguides are fabricated mechanically by sawing the wafer to produce a shallow trench whose depth matches that required for the waveguide. The edge of the saw blade is treated with fine grit so as to polish the edges of the cut thereby making a smooth edge which minimizes loss of the waveguide.

Buried Waveguides

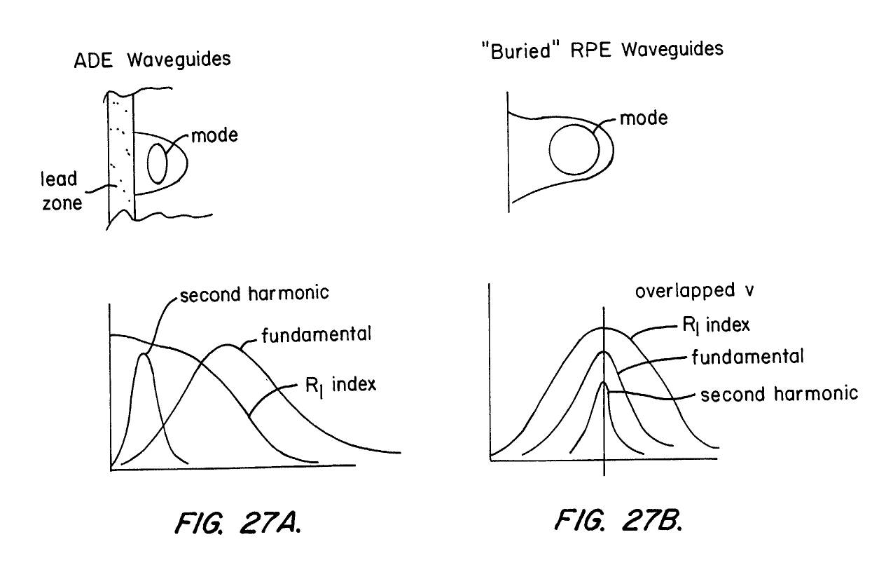

Efficiency of the present invention is improved by using buried waveguides fabricated by reverse proton exchange. In these guides, the fundamental pump and doubled pump are better overlapped which enhances gain. FIG. 27a shows the modes of fundamental and second harmonic pump in annealed proton exchange (APE) waveguides; clearly they are poorly overlapped which reduces efficiency. FIG. 27b shows the same mode profiles in buried waveguide produced by reverse proton exchange (RPE), with much better overlap giving 3× higher efficiency for each nonlinear step; this results in 9× higher overall efficiency for the amplifier. RPE waveguide also improve the fiber coupling loss by making the mode size more round compared to the elliptical modes of APE waveguides.

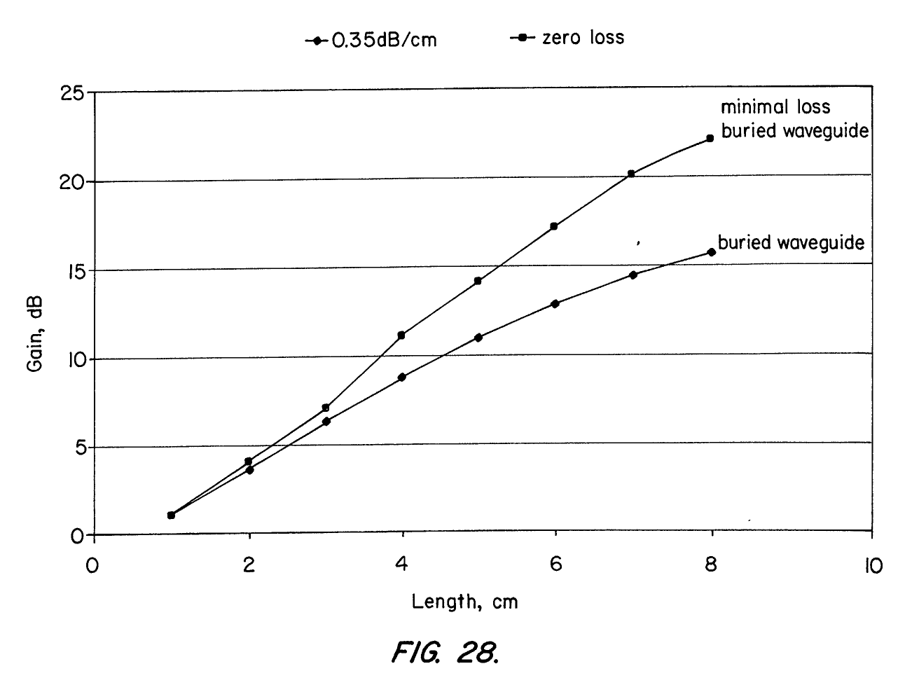

Typical performance of the amplifier is shown in FIG. 28, giving amplification factor as a function of device length for buried waveguide with a normalized efficiency of 150%/cm, and 200 mW pump power, with 0.35 dB loss and zero loss. In the zero loss case, gains up to 22 dB are achieved.

Multi-Channel Amplifiers

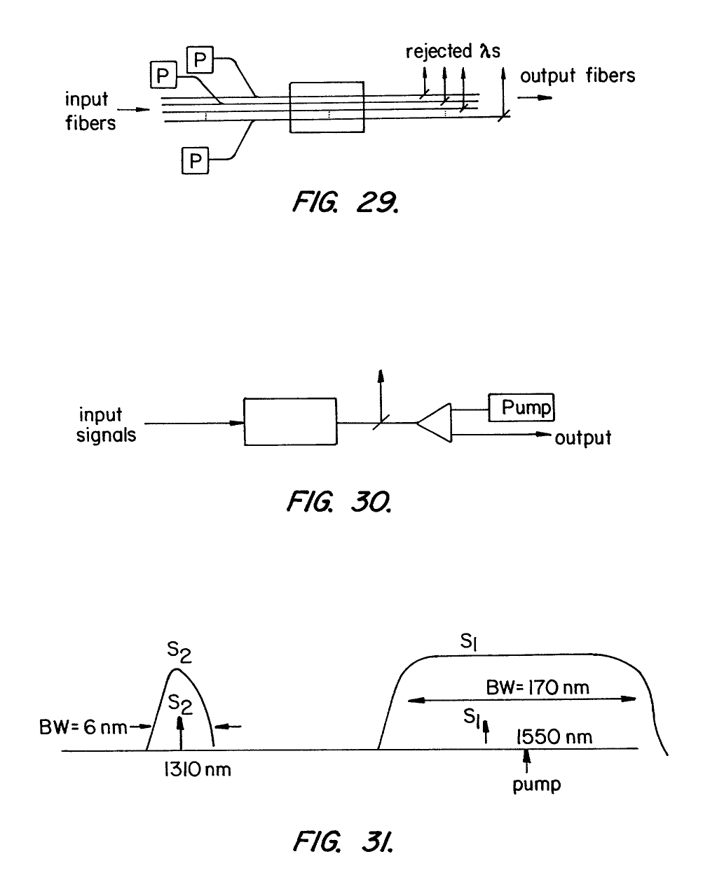

In another embodiment, shown in FIG. 29, a single chip is equipped with multiple waveguides and multiple pumps. An input fiber cable, containing multiple individual fibers is broken out, and each fiber is amplified by an individual waveguide. In this embodiment, cost is minimized by providing many separate amplification paths within a single device with the economy of a single chip. Each amplifier channel has a separate monitor output for evaluation and control.

Backward Amplification

Just as in Raman amplification, even greater improvements in noise performance are achieved in the present invention by counter-propagating the pump with respect to the input signals. This embodiment is shown in FIG. 30.

1310 nm Amplifier

The ability of the present invention enables gain in previously impossible spectral regions. Metro systems use 1310 nm laser diodes because of this low cost, but suffer fairly large fiber propagation losses which limit span length. The present invention can be optimized as a 1310 nm amplifier, enabling much greater span length and offering improves price performance of the metro systems. An embodiment is shown in FIG. 31, and uses an existing 1310 nm, or 1280 nm, or other laser diodes as inexpensive pump sources.

Extended Gain Length Amplifier

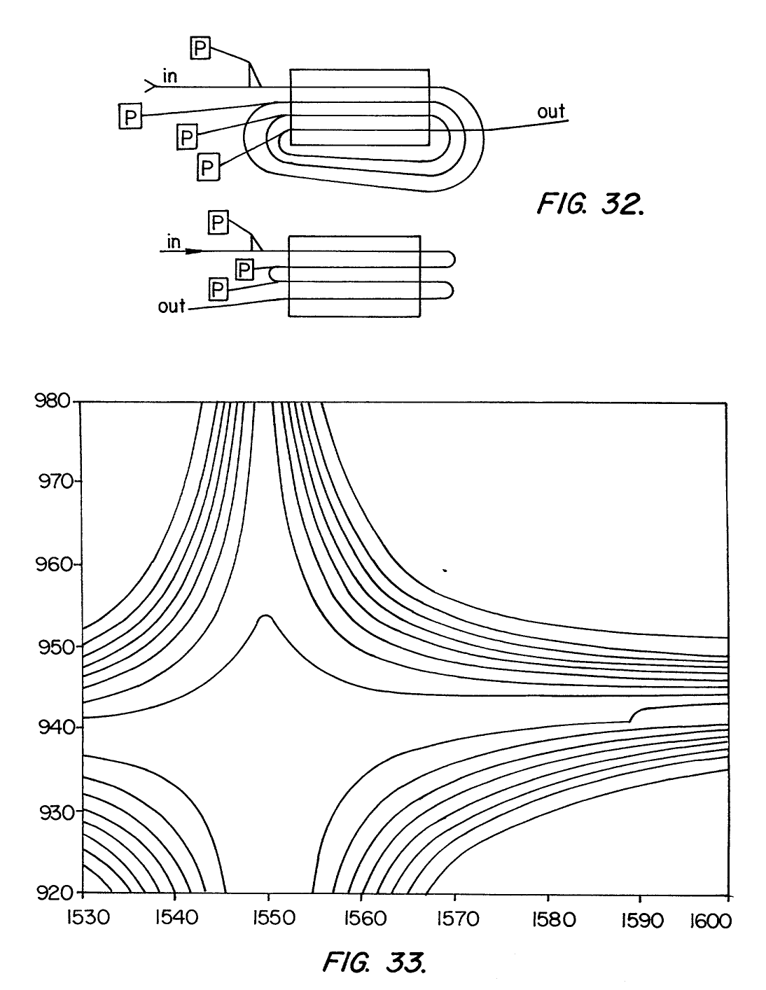

In another embodiment, shown in FIG. 32, multiple waveguides are fabricated in a single chip, optimized for one or more pumps. The effective gain length is increased by looping a fiber between the output of each waveguide and the input of the next. Either a single pump is input by muxing with the input signals, or multiple pumps are input at each loop; these multiple pumps can be at different wavelengths so as to facilitate easy coupling.

The invention have been described with reference to specific embodiments. Other embodiments will be evident to those of ordinary skill in the art. It is therefore not intended that this invention be limited, except as indicated by the appended claims.

What is claimed is:

1. An optical amplifier, comprising
a poled non-linear gain medium,
pump light input arranged with regard to the medium such that light from a pumping source traverses at least some portion of the gain medium,
data signal input arranged with regard to the medium such that light from a data source traverses at least some portion of the gain medium,
at least one output for outputting light from at least the data source having traversed at least some portion of the medium.

2. The amplifier of claim 1 wherein the gain medium is periodically poled.

3. The amplifier of claim 1 wherein the gain medium is aperiodically poled.

4. The amplifier of claim 1 wherein the pump signal input, the gain medium and the data signal input are arranged such that light from the pumping source and light from the data source substantially co-propagate through at least the gain medium.

5. The amplifier of claim 1 wherein the pump signal input, the gain medium and the data signal input are arranged such that light from the pumping source and light from the data source substantially counter-propagate through the gain medium.

6. The amplifier of claim 1 further comprising a pumping source.

7. The amplifier of claim 6 wherein the wavelength of the light emitted by the pumping source is detuned from degeneracy thereby providing enhanced stability.

8. The amplifier of claim 6 wherein the wavelength of the light emitted by the pumping source is detuned from degeneracy thereby providing enhanced bandwidth.

9. The amplifier of claim 6 wherein the pumping source comprises a diode pump.

10. The amplifier of claim 6 wherein the wavelength of the light emitted by the pumping source is in the range of 930-950 nm.

11. The amplifier of claim 6 wherein the wavelength of the light emitted by the pumping source is substantially 940 nm.

12. The amplifier of claim 1 wherein at least a portion of the poled non-linear gain medium is a LiNbO₃ crystal.

12. The amplifier of claim 1 wherein at least a portion of the poled non-linear gain medium is a LiTaO3 crystal.

13. The amplifier of claim 1 wherein at least a portion of the poled non-linear gain medium is a MgO:LiNbO3 crystal.

14. The amplifier of claim 1 wherein the wavelength of the light emitted by the pumping source is a noncritical phasematching wavelength whereby at least a portion of the signal wavelengths are substantially noncritically phased matched.

15. The amplifier of claim 14 wherein the noncritical phasematching wavelength is substantially 940 nm.

16. The method of claim 15 wherein the poled non-linear gain medium has a quasi-phasematching period such that at least a portion of the signal wavelengths are noncritically phased matched.

17 The amplifier of claim 1 wherein at least a portion of the poled non-linear gain medium is incorporated within a waveguide

18. The amplifier of claim 17 wherein the waveguide comprises a proton-exchanged waveguide

19. The amplifier of claim 17 wherein the waveguide comprises a zinc diffused waveguide.

20. The amplifier of claim 17 wherein the waveguide comprises a buried waveguide.

21. The amplifier of claim 17 wherein the waveguide comprises a reverse-proton-exchanged waveguide.

22. The amplifier of claim 17 wherein at least one end of the waveguide is beveled such that it is substantially non-parallel to the direction of propagation of light within the waveguide.

23. The amplifier of claim 17 wherein at least of one the pump input, the data signal input and the output comprises a grating arranged on the surface of said poled non-linear waveguide.

24. The amplifier of claim 17 wherein said waveguide further comprises a high reflectivity surface disposed substantially orthogonal to the direction of propagation of light within said waveguide adapted for directing light such that it substantially reverses direction within the waveguide.

25. The amplifier of claim 1 further comprising a light routing structure within the poled non-linear gain medium adapted for directing light within the gain medium to traverse said medium multiple times.

26. A high gain optical amplifier comprising
a high gain amplifier input,
a high gain amplifier output,
at least a first and a second optical amplifier in series, each amplifier comprising
a poled non-linear gain medium,
pump light input arranged with regard to the medium such that light from a pumping source traverses at least a portio of the gain medium,
data signal input arranged with regard to the medium such that light from a data source traverses a least a portion of the gain medium,
at least one output for outputting light from at least the data source having traversed the medium,
wherein the data signal input of the high gain optical amplifier comprises the data signal input of the first optical amplifier in the series,
and wherein the output of the first optical amplifier is connected to the data signal input of the next amplifier in the series,
and wherein the output of the high gain amplifier comprises the output of the last optical amplifier in the series.

27. A wide band optical amplifier comprising
a PPLN amplification stage comprising,
a poled non-linear gain medium,
pump light input arranged with regard to the medium such that light from a pumping source traverses at least a portion of the gain medium,
data signal means arranged with regard to the medium such that light from a data source traverses at least a portion of the gain medium,
at least one output for outputting light from at least the data source having traversed the medium,
at least one other optical amplifier,
wherein the PPLN amplification stage is connected in series with the other optical amplifier such that a data signal traverses both the amplifier and the other optical amplification means.

28. The wide band optical amplifier of claim 17 wherein the other optical amplifier comprises an erbium doped fiber amplifier.

29. A polarization insensitive optical amplifier comprising
a poled non-linear gain medium,
a data signal input coupled to a data signal optical circulator, the circulator having at least a first and second output ports,
a pump input coupled to a pump optical circulator, the circulator having at least a first and second output ports,
a first polarizing beam splitter coupled to the first output port of the data signal optical circulator, said polarizing beam splitter adapted for directing the energy of a first polarization state along a first data signal path and directing the energy of a second, orthogonal polarization state along a second data signal path,
a second polarizing beam splitter coupled to the first output port of the pump optical circulator, said polarizing beam splitter adapted for directing the energy of a first polarization state along a first pumping signal path and directing the energy of a second, orthogonal polarization state along a second pumping signal path,
a first polarization rotator coupled to said first data signal path adapted for rotating the polarization axis of light propagating along said first data signal path 90°,
a second polarization rotator coupled to said first pumping signal path adapted for rotating the polarization axis of light propagating along said first pumping signal path 90°,
wherein the first data signal path and the first pumping signal path are arranged such that light propagating in said paths propagates through at least a portion of said gain medium,
and wherein the second data signal path and the second pumping signal path are arranged such that light propagating in said paths propagates through said gain medium.

30 The amplifier of claim 29 wherein the polarization rotators are half wave plates.

31. The amplifier of claim 29 wherein the first data signal path and the first pumping signal path are optical fibers and the polarization rotators are realized by providing that the fibers undergo a 90° twist about their long axes as they couple the polarizing beam splitter to the gain medium.

32. A high-gain, polarization insensitive optical amplifier comprising
at least two optical amplifiers, each amplifier comprising
a poled non-linear gain medium,
a data signal input coupled to a data signal optical circulator, the circulator having at least a first and second output ports,
a pump input coupled to a pump optical circulator, the circulator having at least a first and second output ports,
a first polarizing beam splitter coupled to the first output port of the data signal optical circulator, said polarizing beam splitter adapted for directing the energy of a first polarization state along a first data signal path and directing the energy of a second, orthogonal polarization state along a second data signal path,
a second polarizing beam splitter coupled to the first output port of the pump optical circulator, said polarizing beam splitter adapted for directing the energy of a first polarization state along a first pumping signal path and directing the energy of a second, orthogonal polarization state along a second pumping signal path,
a first polarization rotator coupled to said first data signal path adapted for rotating the polarization axis of light propagating along said first data signal path 90°,
a second polarization rotator coupled to said first pumping signal path adapted for rotating the polarization axis of light propagating along said first pumping signal path 90°,
wherein the first data signal path and the first pumping signal path are arranged such that light propagating in said paths propagates through at least a portion of said gain medium,
and wherein the second data signal path and the second pumping signal path are arranged such that light propagating in said paths propagates through at least a portion of said gain medium,
wherein the two amplifiers are arranged such that the second output port of the data signal optical circulator of a given amplifier is coupled to the input port of the data signal optical circulator of the next amplifier in the series,
wherein the second output port of the pump signal optical circulator of a given amplifier is coupled to the input port of the pump signal optical circulator of the next amplifier in the series,
and wherein the output of the amplifier comprises the second output port of the data signal optical circulator of the last amplifier in the series.

33. A method for amplifying at least one optical signal channel, the channel containing at least one optical data signal on a wavelength of λₛ, the method comprising the steps of
propagating the optical data signal through at least a portion of a poled non-linear gain medium,
propagating a pumping signal having a wavelength λₚ through at least a portion of said gain medium,
and arranging said poled gain medium and the pumping wavelength such that energy from the pumping signal is transferred to the optical data signal by the process of difference frequency generation resulting in at least two output signals having the wavelengths λₛ and λ_{c},
wherein λₛ is the wavelength of the amplified optical signal and λ_{c} is the wavelength of the resultant converted wave signal.

34. The method of claim 33 wherein the poled non-linear gain medium is a periodically poled non-linear gain medium.

35. The method of claim 33 wherein the wavelength of the light emitted by the pumping source is detuned from degeneracy thereby providing enhanced stability.

36. The method of claim 33 wherein the wavelength of the light emitted by the pumping source is detuned from degeneracy thereby providing enhanced bandwidth.

37. The method of claim 33 wherein at least a portion of the poled non-linear gain medium is a LiNbO3 crystal.

38. The method of claim 33 wherein at least a portion of the poled non-linear gain medium is a LiTaO3 crystal.

39. The method of claim 33 wherein at least a portion of the poled non-linear gain medium is a MgO:LiNbO3 crystal.

40. The method of claim 33 wherein at least a portion of the poled non-linear gain medium is incorporated within a waveguide

41. The method of claim 40 wherein the waveguide comprises a proton exchanged waveguide

42. The method of claim 40 wherein the waveguide comprises a zinc-diffused waveguide

43. The method of claim 40 wherein the waveguide comprises a buried waveguide

44. The method of claim 40 wherein the waveguide comprises a reverse-proton-exchanged waveguide.

45. The method of claim 33 wherein the gain medium is adapted for use with a diode pump.

46. The method of claim 45 wherein the diode pump emits light having a wavelength substantially 940 nm.

47. The method of claim 45 wherein the diode pump emits light having a noncritical phasematching wavelength whereby at least a portion of the signal wavelengths are substantially noncritically phased matched.

48. The method of claim 47 wherein the noncritical phasematching wavelength is substantially 940 nm.

49. The method of claim 33 wherein the poled non-linear gain medium has a quasi-phasematching period such that at least a portion of the signal wavelengths are noncritically phased matched.

50. The method of claim 33 further comprising the step of detecting the signal having a wavelength λ_{c}.

51. A method for correcting multi-channel crosstalk while amplifying at least two optical signal channels, the channels comprising at least a first optical data signal on a wavelength of λₛ₁, and a second optical data signal on a wavelength of λₛ₂, the method comprising the steps of
propagating the optical data signals through a poled non-linear gain medium,
propagating a pumping signal having a wavelength λₚ through said gain medium,
and arranging the said gain medium such that energy from the pumping signal is transferred to the optical data signals by the process of difference frequency generation resulting in at least three output signals having the wavelengths λₛ₁, λₛ₂, and λ_{c},
wherein λₛ₁ and λₛ₂ are the wavelengths of the amplified optical signal and λ_{c} is the wavelength of the resultant converted wave signal,
detecting the converted wave signal having a wavelength λ_{c},
and adjusting pump power in response to the amplitude of the signal having λ_{c}.

52. A method for providing wide band optical amplification the method comprising the steps of
applying an optical signal to at least a first optical amplifier having a first spectral gain distribution G(λ)₁,
further amplifying the signal by
propagating the optical data signal through a poled non-linear gain medium,
propagating a pumping signal having a wavelength λₚ through said gain medium,
and arranging the gain medium such that energy from the pumping signal is transferred to the optical data signal by the process of difference frequency generation resulting in at least two output signals having the wavelengths λₛ and λ_{c},
wherein λₛ is the wavelength of the amplified optical signal and λ_{c} is the wavelength of the resultant converted wave signal,
wherein the polling period and pumping wavelength are chosen such that said further amplification results in a spectral gain distribution G(λ)₂,
and wherein the combination of G(λ)₁+G(λ)₂ provides a total spectral gain distribution which is substantially flat over a wavelength band of interest.

53. The amplifier of claim 52 wherein the wavelength of the light emitted by the pumping source is detuned from degeneracy thereby providing enhanced stability.

54. The amplifier of claim 52 wherein the wavelength of the light emitted by the pumping source is detuned from degeneracy thereby providing enhanced bandwidth.

55. The method of claim 52 wherein the first optical amplifier is an EDFA.

56. A method for characterizing a waveguide, the method comprising the steps of
providing a PPLN device having serrations disposed thereon as optical couplers,
contacting said PPLN device with said waveguide such that the long axis of said amplifier is substantially parallel to the long axis of said waveguide,
propagating a test signal along said waveguide such that the test signal is coupled from said waveguide to said PPLN device through said PPLN device's input grating and out of said PPLN device back into said waveguide through said PPLN device's output grating,
and detecting said test signal.

57. The method of claim 42 wherein said waveguide is characterized at the wafer level.
